(19) United States
(12) Patent Application Publication
(10) Pub. No.: US 2020/0084589 A1
(43) Pub. Date: Mar. 12, 2020

(54) COMMUNICATION SYSTEM, METHOD AND DATA FORWARDING DEVICE FOR MULTIMEDIA BROADCAST/MULTICAST SERVICE

(71) Applicant: Institute For Information Industry, Taipei (TW)

(72) Inventor: Chun-Yen HSU, Taipei City (TW)

(21) Appl. No.: 16/181,336

(22) Filed: Nov. 5, 2018

(30) Foreign Application Priority Data
Sep. 6, 2018 (TW) 107131336

(51) Int. Cl. H04W 4/08; H04L 12/18; H04W 56/00; H04W 72/00

(52) U.S. Cl. CPC H04W 4/08; H04W 72/005; H04W 56/0005; H04L 12/189

(57) ABSTRACT

A multimedia broadcast/multicast service (MBMS) data forwarding device transmits a multicast IP address to a base station so that the base station joins a multicast group according to the multicast internet protocol address. The MBMS data forwarding device also transmits an entry network address to a content provider to receive MBMS data from the content provider, and forwards the MBMS data to the base station, thereby improving a transmission path on which the base station receives the MBMS data.

### PRIORITY

This application claims priority to Taiwan Patent Application No. 107131336 filed on Sep. 6, 2018, which is hereby incorporated herein by reference in its entirety.

### FIELD

The present disclosure relates to a communication system and a communication method. More particularly, the present disclosure relates to a communication system in support of multimedia broadcast/multicast service (MBMS), a method providing the MBMS and an MBMS data forwarding device.

### BACKGROUND

FIG. 1 illustrates a schematic view of a conventional communication system in support of MBMS. As shown in FIG. 1, the conventional communication system 1 comprises a content provider CPD, a broadcast/multicast service center BM-SC, an MBMS gateway GW, a mobility management entity MME, an MBMS coordination entity MCE (or named Multi-cell/Multicast Coordination Entity) and a base station BS. There are control planes configured to transmit MBMS control signals between the content provider CPD, the broadcast/multicast service center BM-SC, the MBMS gateway GW, the mobility management entity MME, the MBMS coordination entity MCE and the base station BS. Additionally, there are user planes configured to transmit MBMS data between the content provider CPD, the broadcast/multicast service center BM-SC, the MBMS gateway GW and the base station BS.

In order to transmit the MBMS data provided by the content provider CPD to the user equipment served by the conventional communication system 1, the content provider CPD transmits MBMS control signals to the base station BS via the control planes between the broadcast multicast service center BM-SC, the MBMS gateway GW, the mobility management entity MME and the MBMS coordination entity MCE sequentially. Then, the base station BS completes the preparation required to receive the MBMS data according to the MBMS control signals. After the base station BS completes the preparation, the content provider CPD transmits the MBMS data to the base station BS via the user planes between the content provider CPD, the broadcast multicast service center BM-SC and the MBMS gateway GW sequentially, so that the base station BS provides the MBMS data to the user equipment.

In the conventional communication system 1, the broadcast/multicast service center BM-SC plays an important role for receiving the MBMS control signal and the MBMS data from the content provider CPD and transferring them to the base station BS. Therefore, the broadcast/multicast service center BM-SC always faces enormous workload because all MBMS control signals and MBMS data streams must pass through it. In other words, the broadcast/multicast service center BM-SC often becomes the bottleneck of the MBMS network. Such a phenomenon often cause latency and/or jitter to the transmission of MBMS data, especially the streaming data, thereby affecting the quality of the MBMS. Therefore, it is important in the field to which the present disclosure pertains to improve the transmission quality of the MBMS.

### SUMMARY

To solve at least the aforesaid problem, provided herein is a communication system in support of multimedia broadcast/multicast service (MBMS). The communication system may comprise a content provider, a base station, and an MBMS data forwarding device coupled to the content provider and the base station respectively. The MBMS data forwarding device may be configured to transmit an entry network address to the content provider, and transmit a multicast internet protocol address to the base station. The content provider may be configured to transmit MBMS data to the MBMS data forwarding device according to the entry network address. The base station may be configured to join a multicast group according to the multicast internet protocol address. The MBMS data forwarding device may further be configured to forward the MBMS data to the base station that has joined the multicast group.

Also provided is a method of providing MBMS. The method may comprise:
transmitting, by an MBMS data forwarding device, a multicast internet protocol address to a base station;
joining, by the base station, a multicast group according to the multicast internet protocol address;
transmitting, by the MBMS data forwarding device, an entry network address to a content provider;
transmitting, by the content provider, MBMS data to the MBMS data forwarding device according to the entry network address; and
forwarding, by the MBMS data forwarding device, the MBMS data to the base station that has joined the multicast group.

Further provided is an MBMS data forwarding device. The MBMS data forwarding device may comprise a transceiver and a processor electrically connected with the transceiver. The transceiver may be configured to transmit an entry network address to a content provider to receive MBMS data from the content provider. The transceiver may further be configured to transmit a multicast internet protocol address to a base station such that the base station joins a multicast group according to the multicast internet protocol address. The transceiver may also be configured to forward the MBMS data to the base station that has joined the multicast group. The processor may be configured to assign the multicast internet protocol address for the base station and assign the entry network address for the content provider.

To sum up, a shortcut for transmitting MBMS data to the base station is provided by the present disclosure. With this shortcut, the content provider can directly transmit the MBMS data to the MBMS data forwarding device, and then the MBMS data forwarding device forwards the received MBMS data directly to the base station. Since the MBMS data provided by the content provider, especially the streaming data, does not need to be transmitted through the broadcast/multicast service center BM-SC, which is prone to traffic congestion, it would improve data latency and/or jitter or the like, thereby improving the service quality of MBMS.

The aforesaid content is not intended to limit the present invention, but merely describes the technical problems that can be solved by the present invention, the technical means that can be adopted, and the technical effects that can be achieved, so that people having ordinary skill in the art can basically understand the present invention. People having ordinary skill in the art can understand the various embodiments of the present invention according to the attached figures and the content recited in the following embodiments.

### BRIEF DESCRIPTION OF THE DRAWINGS

FIG. 1 illustrates a schematic view of a conventional communication system supporting MBMS.

FIG. 2A illustrates a structure of a communication system supporting MBMS according to one or more embodiments of the present invention.

FIG. 2B illustrates an alternate of the structure shown in FIG. 2A.

FIG. 2C illustrates another alternate of the structure shown in FIG. 2A.

FIG. 2D illustrates another different alternate of the structure shown in FIG. 2A.

FIG. 3A and FIG. 3B illustrate a schematic view of how the communication system shown in FIG. 2A and FIG. 2B provide MBMS according to one or more embodiments of the present invention.

FIG. 4A and FIG. 4B illustrate a schematic view of how the communication system shown in FIG. 2C provides MBMS according to one or more embodiments of the present invention.

FIG. 5A and FIG. 5B illustrate a schematic view of how the communication system shown in FIG. 2D provides MBMS according to one or more embodiments of the present invention.

FIG. 6 illustrates a schematic view of a method of providing MBMS according to one or more embodiments of the present invention.

### DETAILED DESCRIPTION

The exemplary embodiments described below are not intended to limit the present invention to any specific environment, example, embodiment, applications, structures, processes or steps as described in these example embodiments.

In the attached figures, elements not directly related to the present invention are omitted from depiction. In the attached figures, dimensional relationships among individual elements in the attached drawings are merely examples but not to limit the actual scale. Unless otherwise described, the same (or similar) element symbols may correspond to the same (or similar) elements in the following description. Unless otherwise described, the number of each element described below may be one or more under implementable circumstances.

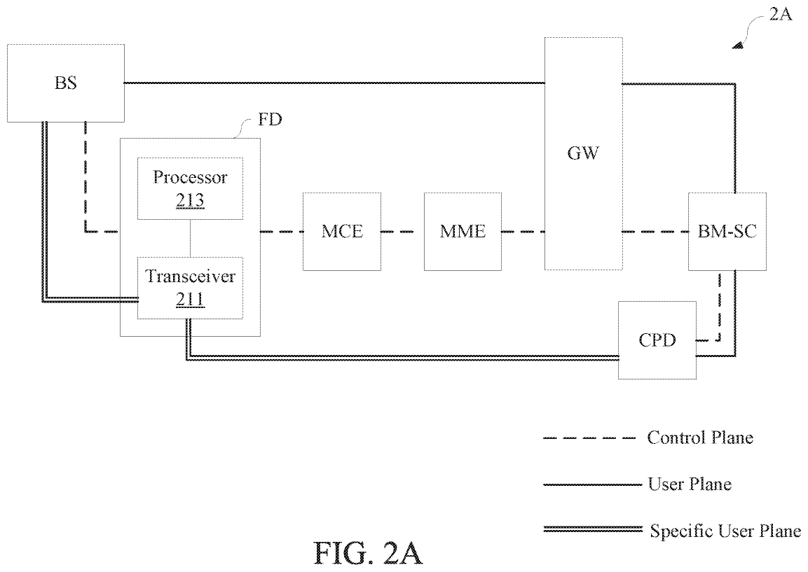

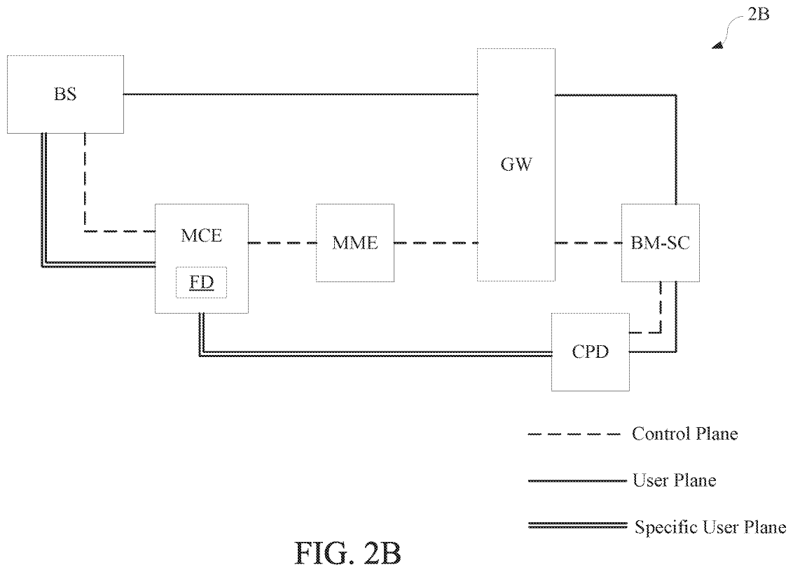

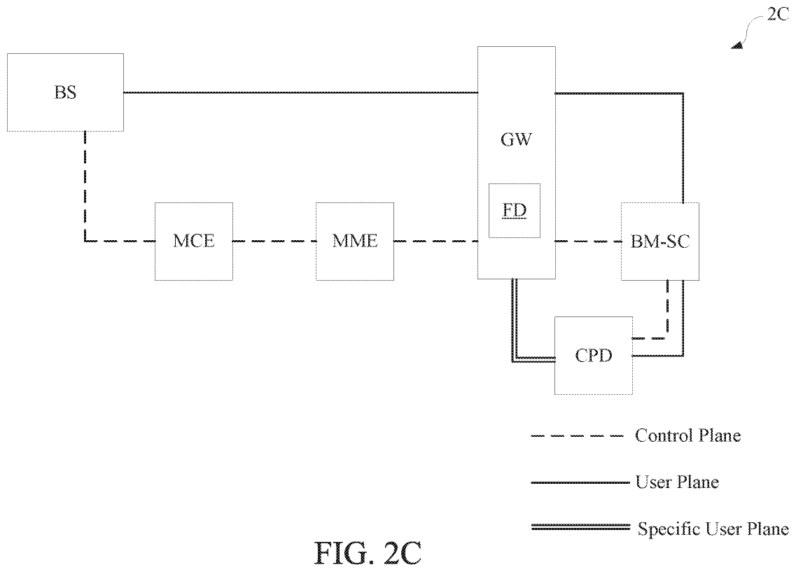

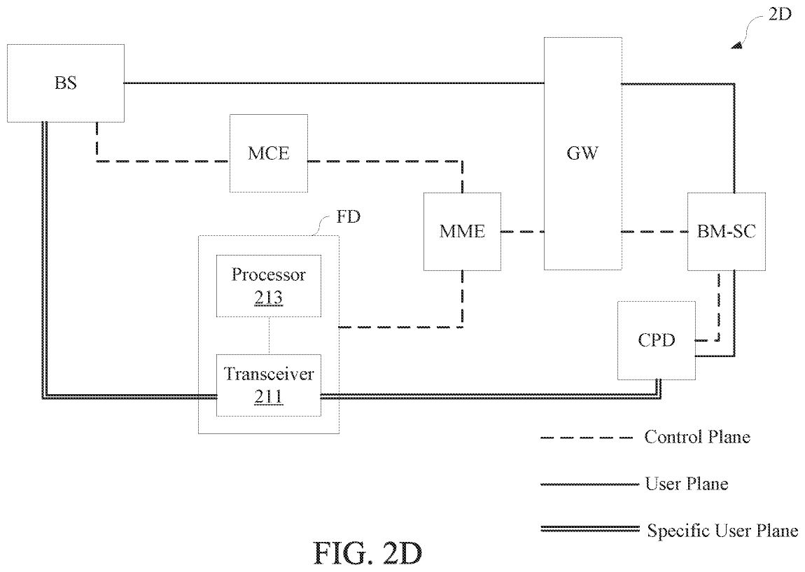

FIG. 2A illustrates a structure of a communication system supporting MBMS according to one or more embodiments of the present invention. However, contents of FIG. 2A are presented merely for explaining the embodiments of the present invention, but not to limit the present invention.

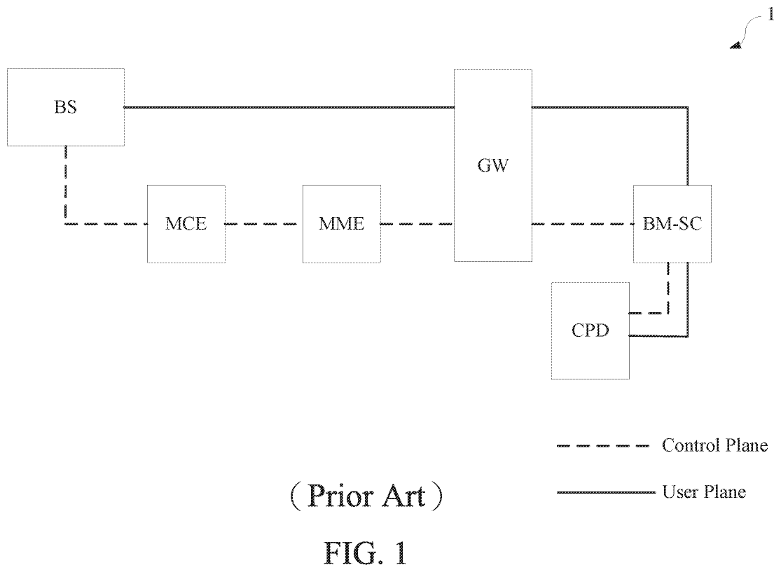

Referring to FIG. 1 and FIG. 2A, as same as the conventional communication system 1, the communication system 2A supporting MBMS may comprise a content provider CPD, a broadcast/multicast service center BM-SC, an MBMS gateway GW, a mobility management entity MME, an MBMS coordination entity MCE (also known as a multi-cell/multicast coordination entity) and a base station BS. In the communication system 2A, there may be control planes for transmitting MBMS control signals between the content provider CPD, the broadcast/multicast service center BM-SC, the MBMS gateway GW, the mobility management entity MME and the MBMS coordination entity MCE. In addition, there may also be user planes for transmitting MBMS data between the broadcast/multicast service center BM-SC, the MBMS gateway GW and the base station BS.

A difference between the communication system 2A and the conventional communication system 1 is that the communication system 2A additionally comprises an MBMS data forwarding device FD. The MBMS data forwarding device FD is disposed between the MBMS coordination entity MCE and the base station BS, and is directly coupled with the MBMS coordination entity MCE, the content provider CPD, and the base station BS. Also, the MBMS data forwarding device FD is indirectly coupled with the broadcast/multicast service center BM-SC, the MBMS gateway GW and the mobility management entity MME. There are control planes for transmitting MBMS control signals between the MBMS data forwarding device FD, the MBMS coordination entity MCE and the base station BS. In addition, there are specific user planes for transmitting MBMS data between the MBMS data forwarding device FD, the content provider CPD and the base station BS.

The MBMS data forwarding device may basically comprise a transceiver 211 and a processor 213 electrically connected to the transceiver 211. The transceiver 211 may be electrically connected to the processor 213 without through other elements (namely electrically connected to each other directly). Alternatively, the transceiver 211 may be electrically connected to the processor 213 through other elements (namely electrically connected to each other indirectly).

The transceiver 211 may be composed of a transmitter and a receiver and may comprise, for example but not limited to, an antenna, an amplifier, a modulator, a demodulator, a detector, an analog to digital converter, a digital to analog converter, etc.

The processor 213 may be a microprocessor or a microcontroller capable of signal processing. The microprocessor (or the microcontroller) is a programmable specific integrated circuit which is capable of operating, storing, outputting/inputting, etc., and may receive and process various instructions, thereby performing various logical operations and arithmetic operations, and outputting corresponding operational results. The processor 213 may be programed to execute various operations or programs in the MBMS data forwarding device FD.

The processor 213 may be configured to assign a multicast internet protocol address for the base station BS and assign an entry network address for the content provider CPD. The transceiver 211 may be configured to transmit the entry network address to the content provider CPD to receive MBMS data from the content provider CPD. The transceiver 211 may further be configured to transmit the multicast internet protocol address to the base station BS, so that the base station BS can join a multicast group according to the multicast internet protocol address. In addition, the transceiver 211 may also be configured to forward the MBMS data to the base station BS that has joined the multicast group. In the communication system 2A, the content provider CPD may transmit the MBMS data to the base station BS only through the MBMS data forwarding device FD, so that the MBMS data may be prevented from passing through the broadcast/multicast service center BM-SC, which is prone to traffic congestion, thereby improving the service quality of MBMS data.

FIG. 2B illustrates an alternate of the structure shown in FIG. 2A. However, contents of FIG. 2B are presented merely for explaining the embodiments of the present invention, but not to limit the present invention.

As compared with the communication system 2A, the communication system 2B shown in FIG. 2B features that the MBMS data forwarding device FD is integrated into the MBMS coordination entity MCE. Under the circumstances, the MBMS data forwarding device FD may be a part of the MBMS coordination entity MCE, and share the transceiver 211 and the processor 213 with the MBMS coordination entity MCE. In other words, the MBMS data forwarding device FD, in some embodiments, may be implemented by the MBMS coordination entity MCE. There is no difference about the functions of the MBMS data forwarding device FD between FIG. 2A and FIG. 2B. Therefore, in FIG. 2B, there are specific user planes for transmitting MBMS data between the MBMS coordination entity MCE, the content provider CPD and the base station BS according to the MBMS data forwarding device FD. Under this structure, the content provider CPD can transmit the MBMS data to the base station BS only through the MBMS coordination entity MCE, and hence the MBMS data can also be prevented from passing through the broadcast/multicast service center BM-SC which is prone to traffic congestion, thereby improving the transmission quality of MBMS data.

FIG. 2C illustrates another alternate of the structure shown in FIG. 2A. However, contents of FIG. 2C are presented merely for explaining the embodiments of the present invention, but not to limit the present invention.

As compared with the communication system 2A, the communication system 2C shown in FIG. 2C features that the MBMS data forwarding device FD is integrated into the MBMS gateway GW. Under the circumstances, the MBMS data forwarding device FD may be a part of the MBMS gateway GW, and may share the transceiver 211 and the processor 213 with the MBMS gateway GW. In other words, the MBMS data forwarding device FD, in some embodiments, may be implemented by the MBMS gateway GW. There is no difference about the functions of the MBMS data forwarding device FD between FIG. 2A and FIG. 2C. Therefore, in FIG. 2C, there is a specific user plane for transmitting MBMS data between the MBMS gateway GW and the content provider CPD according to the MBMS data forwarding device FD. In addition, there is still a conventional user plane for transmitting MBMS data between the MBMS gateway GW and the base station BS. Under this structure, the content provider CPD can transmit the MBMS data to the base station BS only through the MBMS gateway GW, and hence the MBMS data can also be prevented from passing through the broadcast/multicast service center BM-SC which is prone to traffic congestion, thereby improving the service quality of MBMS data.

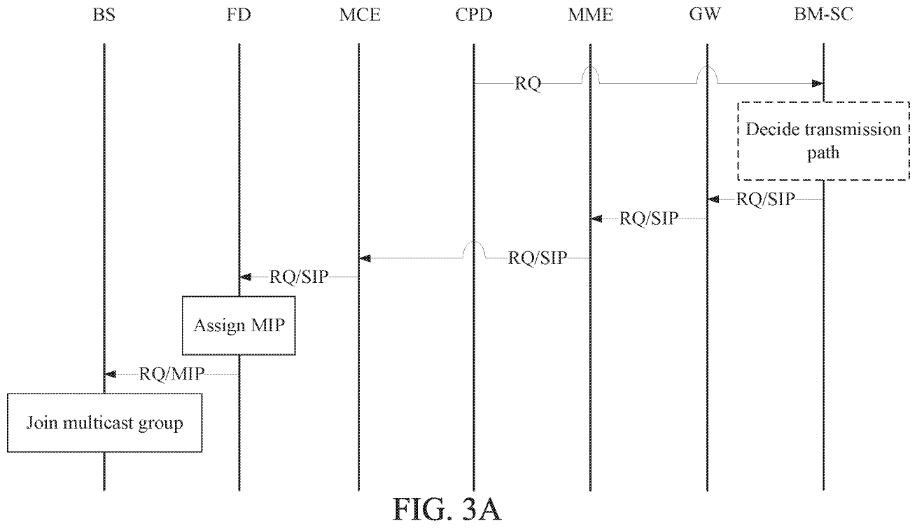

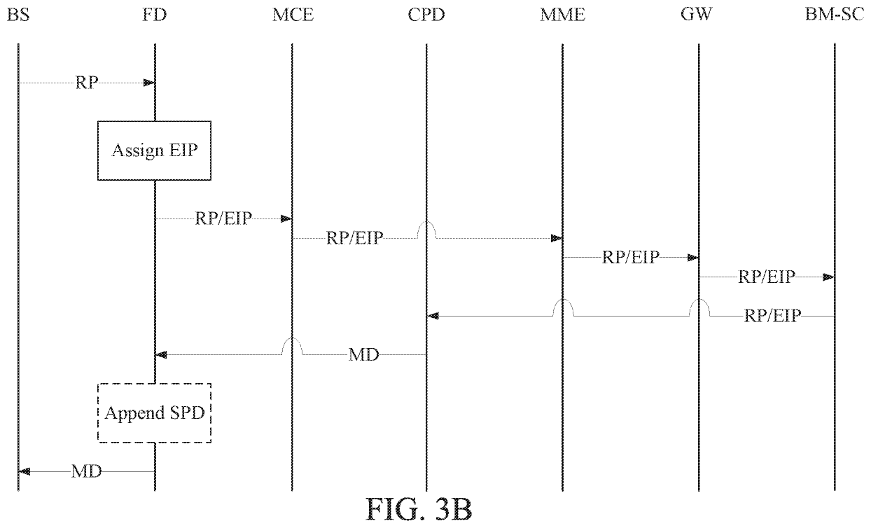

FIG. 3A and FIG. 3B illustrate a schematic view of how the communication system shown in FIG. 2A and FIG. 2B provide MBMS according to one or more embodiments of the present invention. However, contents of FIG. 3A and FIG. 3B are presented merely for explaining the embodiments of the present invention, but not to limit the present invention.

Referring to FIG. 2A and FIGS. 3A-3B or FIG. 2B and FIGS. 3A-3B, when the communication system 2A or the communication system 2B is attempting to provide MBMS, the content provider CPD may transmit an MBMS session-start request RQ to the broadcast/multicast service center BM-SC on the control plane. In some embodiments, if the communication system 2A or the communication system 2B is able to support both of a conventional transmission path (i.e., the MBMS data of the content provider CPD needs to be transmitted to the broadcast/multicast service center BM-SC) and the improved transmission path (i.e., the MBMS data of the content provider CPD does not need to be transmitted to the broadcast/multicast service center BM-SC), the broadcast/multicast service center BM-SC may decide and choose one from the two transmission paths based on various factors (for example but not limited to: the network transmission status, the current workload, etc.) after receiving the MBMS session-start request RQ. Under the circumstances, the broadcast/multicast service center BM-SC also affects the subsequent operations of the MBMS data forwarding device FD. The subsequent operations of the MBMS data forwarding device FD may at least include transmitting an entry network address EIP to the content provider CPD and transmitting a multicast internet protocol address MIP to the base station BS.

In some embodiments, if the communication system 2A or the communication system 2B is only able to support the improved transmission path (i.e., the MBMS data of the content provider CPD does not need to be transmitted to the broadcast/multicast service center BM-SC), the broadcast/multicast service center BM-SC may directly transmit a MBMS session-start request RQ to the MBMS gateway GW according to the MBMS session-start request RQ received from the content provider CPD.

When the improved transmission path (i.e., the MBMS data of the content provider CPD does not need to be transmitted to the broadcast/multicast service center BM-SC) is chosen, the broadcast/multicast service center BM-SC may inform the base station BS that the content provider CPD is going to provide MBMS. In the communication system 2A, an MBMS session-start request RQ may be transmitted on the control planes from the broadcast/multicast service center BM-SC to the base station BS through the MBMS gateway GW, the mobility management entity MME, the MBMS coordination entity MCE, and the MBMS data forwarding device FD. In the communication system 2B, since the MBMS data forwarding device FD is integrated into the MBMS coordination entity MCE, a MBMS session-start request RQ may be transmitted on the control planes from the broadcast/multicast service center BM-SC to the base station BS through the MBMS gateway GW, the mobility management entity MME, and the MBMS coordination entity MCE. Any one of the broadcast/multicast service center BM-SC, the MBMS gateway GW, the mobility management entity MME, the MBMS coordination entity MCE, and the MBMS data forwarding device FD may directly forward the received MBMS session-start request RQ to the next node, or may modify the content and/or format of the received MBMS session-start request RQ, and then transmit the modified MBMS session-start request RQ to the next node.

The MBMS session-start request RQ transmitted to the transceiver 211 of the MBMS data forwarding device FD may carry a source network address SIP associated with the content provider CPD. According to the source network address SIP, the processor 213 of the MBMS data forwarding device FD may identify the content provider CPD whose MBMS data is received afterwards by the transceiver 211. For different requirements, the source network address SIP may comprise only a source internet protocol (IP) address, or may comprise the source internet protocol address and a source port.

After receiving the MBMS session-start request RQ, the processor 213 of the MBMS data forwarding device FD may create a multicast group and assign a multicast internet protocol address MIP associated with the multicast group for the base station BS. Then, the transceiver 211 of the MBMS data forwarding device FD may transmit the MBMS session-start request RQ carrying the multicast internet protocol address MIP to the base station BS. Upon receipt of the MBMS session-start request RQ, the base station BS may join the multicast group according to the multicast internet protocol address MIP.

After joining the multicast group, the base station BS may reply with an MBMS session-start response RP to the MBMS data forwarding device FD of the communication system 2A or the MBMS coordination entity MCE of the communication system 2B. After receiving the MBMS session-start response RP, the processor 213 of the MBMS forwarding device FD may assign an entry network address EIP for the content provider CPD and attach the entry network address EIP to the MBMS session-start response RP which is to be transmitted by transceiver 211 of the MBMS forwarding device FD. In the communication system 2A, the MBMS session-start response RP carrying the entry network address EIP may be transmitted on the control planes between the MBMS forwarding device FD and the content provider CPD through the MBMS coordination entity MCE, the mobility management entity MME, the MBMS gateway GW, and the broadcast/multicast service center BM-SC to complete the session-start signaling procedure of the MBMS session. In the communication system 2B, since the MBMS data forwarding device FD is integrated into the MBMS coordination entity MCE, the MBMS session-start response RP carrying the entry network address EIP may be transmitted on the control planes between the MBMS coordination entity MCE and the content provider CPD through the mobility management entity MME, the MBMS gateway GW, and the broadcast/multicast service center BM-SC to complete the session-start signaling procedure of the MBMS session. Any one of the MBMS data forwarding device FD, the MBMS coordination entity MCE, the mobility management entity MME, the MBMS gateway GW, and the broadcast/multicast service center BM-SC may directly forward the received MBMS session-start response RP to the next node, or may modify the content and/or format of the received MBMS session-start response RP, and then transmit the modified MBMS session-start response RP to the next node. For different requirements, the entry network address EIP may comprise only an entry internet protocol (IP) address, or may comprise the entry internet protocol address and an entry port.

After receiving the MBMS session-start response RP, the content provider CPD may directly transmit the MBMS data MD to the MBMS data forwarding device FD on the specific user plane between the content provider CPD and the MBMS data forwarding device FD according to the entry network address EIP. For example, after receiving the MBMS session-start response RP, the content provider CPD may establish a forwarding tunnel (for example but not limited to an Internet Protocol Security tunnel, abbreviated to an IPsec tunnel) on the specific user plane between the content provider CPD itself and the MBMS data forwarding device FD according to the entry network address EIP, and then directly transmit the MBMS data MD to the MBMS data forwarding device FD of the communication system 2A or the MBMS coordination entity MCE of the communication system 2B via the forwarding tunnel.

In the communication system 2A, after receiving the MBMS data MD, the transceiver 211 of the MBMS data forwarding device FD may forward, in a multicast way, the MBMS data MD to the base station BS that has joined the multicast group on the specific user plane between the MBMS data forwarding device FD and the base station BS. In the communication system 2B, after receiving the MBMS data MD, the MBMS coordination entity MCE may forward, in a multicast way, the MBMS data MD to the base station BS that has joined the multicast group on the specific user plane between the MBMS coordination entity MCE and the base station BS. Then, the base station BS may provide the MBMS data MD to the user equipment which it serves.

In some embodiments, the processor 213 of the MBMS data forwarding device FD may selectively append an MBMS synchronization (SYNC) protocol data SPD to the MBMS data MD to be transmitted to the base station BS. After receiving the MBMS data MD, the base station BS may obtain a time stamp from the MBMS synchronization protocol data SPD for synchronizing the transmission of the MBMS data MD. Details of the synchronization protocol may be found by referring to “3GPP TS 25.446: “MBMS synchronisation protocol (SYNC)””.

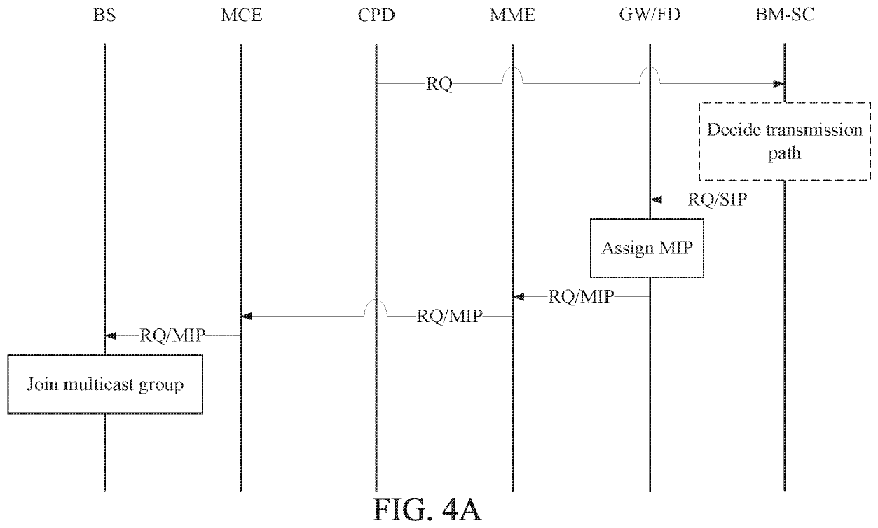

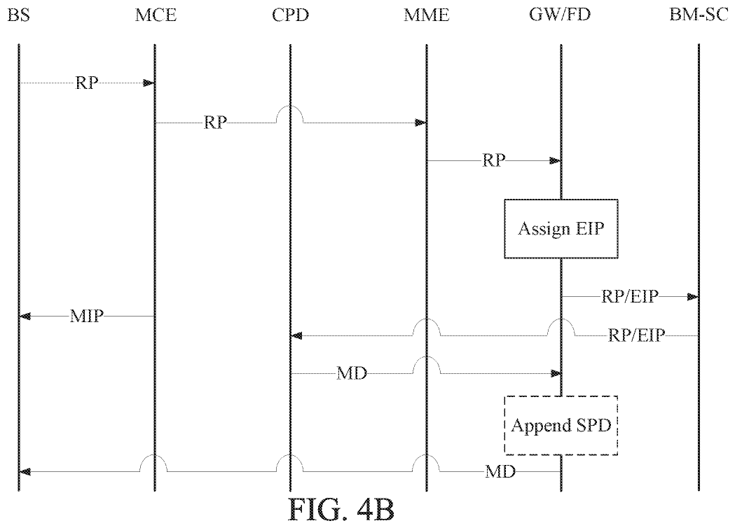

FIG. 4A and FIG. 4B illustrate a schematic view of how the communication system shown in FIG. 2C provides MBMS according to one or more embodiments of the present invention. However, contents of FIG. 4A and FIG. 4B are presented merely for explaining the embodiments of the present invention, but not to limit the present invention.

Referring to FIG. 2C and FIGS. 4A-4B, when the communication system 2C is attempting to provide MBMS, the content provider CPD may transmit an MBMS session-start request RQ to the broadcast/multicast service center BM-SC on the control plane. In some embodiments, if the communication system 2C is able to support both of a conventional transmission path (i.e., the MBMS data of the content provider CPD needs to be transmitted to the broadcast/multicast service center BM-SC) and the improved transmission path (i.e., the MBMS data of the content provider CPD does not need to be transmitted to the broadcast/multicast service center BM-SC), the broadcast/multicast service center BM-SC may decide and choose one from the two transmission paths based on various factors (for example but not limited to: the network transmission status, the current workload, etc.) after receiving the MBMS session-start request RQ. Under the circumstances, the broadcast/multicast service center BM-SC also affects the subsequent operations of the MBMS data forwarding device FD. The subsequent operations of the MBMS data forwarding device FD may at least include transmitting an entry network address EIP to the content provider CPD and transmitting a multicast internet protocol address MIP to the base station BS.

In some embodiments, if the communication system 2A or the communication system 2B is only able to support the improved transmission path (i.e., the MBMS data of the content provider CPD does not need to be transmitted to the broadcast/multicast service center BM-SC), the broadcast/multicast service center BM-SC may directly transmit a MBMS session-start request RQ to the MBMS gateway GW according to the MBMS session-start request RQ received from the content provider CPD.

When the improved transmission path (i.e., the MBMS data of the content provider CPD does not need to be transmitted to the broadcast/multicast service center BM-SC) is chosen, the broadcast/multicast service center BM-SC may inform the base station BS that the content provider CPD is going to provide MBMS, by the MBMS session-start request RQ transmitted on the control planes from the broadcast/multicast service center BM-SC to the base station BS through the MBMS gateway GW, the mobility management entity MME, the MBMS coordination entity MCE, and the MBMS data forwarding device FD. Any one of the broadcast/multicast service center BM-SC, the MBMS gateway GW, the mobility management entity MME, the MBMS coordination entity MCE, and the MBMS data forwarding device FD may directly forward the received MBMS session-start request RQ to the next one, or may modify the content and/or format of the received MBMS session-start request RQ, and then transmit the modified MBMS session-start request RQ to the next one.

The MBMS session-start request RQ transmitted to the MBMS gateway GW may carry a source network address SIP associated with the content provider CPD. According to the source network address SIP, the MBMS data forwarding device FD integrated into the MBMS gateway GW may identify the content provider CPD whose MBMS data is received afterwards by the transceiver 211. For different requirements, the source network address SIP may comprise only a source internet protocol (IP) address, or may comprise the source internet protocol address and a source port.

After the MBMS gateway GW receives the MBMS session-start request RQ, the MBMS data forwarding device FD integrated into the MBMS gateway GW may create a multicast group and assign a multicast internet protocol address MIP associated with the multicast group for the base station BS. Then, the MBMS session-start request RQ each carrying the multicast internet protocol address MIP may be transmitted from the MBMS gateway GW to the base station BS through the MBMS coordination entity MCE and the mobility management entity MME. Upon receipt of the MBMS session-start request RQ, the base station BS may join the multicast group according to the multicast internet protocol address MIP.

After the base station BS joins the multicast group, the MBMS session-start response RP may be transmitted on the control planes from the base station BS to the MBMS gateway GW through the MBMS coordination entity MCE and the mobility management entity MME. After the MBMS gateway GW receives the MBMS session-start response RP, the MBMS forwarding device FD integrated into the MBMS gateway GW may assign an entry network address EIP for the content provider CPD and attach the entry network address EIP to the MBMS session-start response RP. Then, the MBMS session-start response RP each carrying the entry network address EIP may be transmitted on the control planes from the MBMS gateway GW to the content provider CPD through the broadcast/multicast service center BM-SC to complete the session-start signaling procedure of the MBMS session. Any one of the MBMS coordination entity MCE, the mobility management entity MME, the MBMS gateway GW and the broadcast/multicast service center BM-SC may directly forward the received MBMS session-start response RP to the next one, or may modify the content and/or format of the received MBMS session-start response RP, and then transmit the modified MBMS session-start response RP to the next one. For different requirements, the entry network address EIP may comprise only an entry internet protocol (IP) address, or may comprise the entry internet protocol address and an entry port.

After receiving the MBMS session-start response RP, the content provider CPD may directly transmit the MBMS data MD to the MBMS data forwarding device FD integrated into the MBMS gateway GW on the specific user plane between the content provider CPD and the MBMS data forwarding device FD according to the entry network address EIP. For example, after receiving the MBMS conference response RP, the content provider CPD may establish a forwarding tunnel (for example but not limited to an IPsec tunnel) on the specific user plane between the content provider CPD itself and the MBMS data forwarding device FD according to the entry network address EIP, and then directly transmit the MBMS data MD to the MBMS data forwarding device FD via the forwarding tunnel.

After receiving the MBMS data MD, the MBMS data forwarding device FD may forward, in a multicast way, the MBMS data MD to the base station BS that has joined the multicast group on the conventional user plane between the MBMS gateway GW and the base station BS. Then, the base station BS may provide the MBMS data MD to the user equipment which it serves.

In some embodiments, the MBMS data forwarding device FD may selectively append an MBMS synchronization (SYNC) protocol data SPD to the MBMS data MD to be transmitted to the base station BS. After receiving the MBMS data MD, the base station BS may obtain a time stamp from the MBMS synchronization protocol data SPD for synchronizing the MBMS data MD. Details of the synchronization protocol may be found by referring to “3GPP TS 25.446: “MBMS synchronisation protocol (SYNC)””.

FIG. 2D illustrates another different alternate of the structure shown in FIG. 2A. However, contents of FIG. 2D are presented merely for explaining the embodiments of the present invention, but not to limit the present invention.

As compared with the communication system 2A, the communication system 2D shown in FIG. 2D features that the MBMS data forwarding device FD is directly coupled with the mobility management entity MME, the content provider CPD and the base station BS, and is indirectly coupled with the MBMS coordination entity MCE, the broadcast/multicast service center BM-SC and the MBMS gateway GW. In addition, there is a control plane for transmitting MBMS control signals between the MBMS data forwarding device FD and the mobility management entity MME, and there are specific user planes for transmitting MBMS data between the MBMS data forwarding device FD and the content provider CPD and between the content provider CPD and the base station BS respectively.

As same as the MBMS data forwarding device FD of FIG. 2A, the MBMS data forwarding device FD of FIG. 2D is a standalone device staying away from the broadcast/multicast service center BM-SC too. In this case, the content provider CPD can also transmit the MBMS data to the base station BS only through the MBMS data forwarding device FD, and thus prevent the MBMS data from flowing through the broadcast/multicast service center BM-SC, which is prone to the traffic congestion, thereby improving the quality of MBMS data transmission.

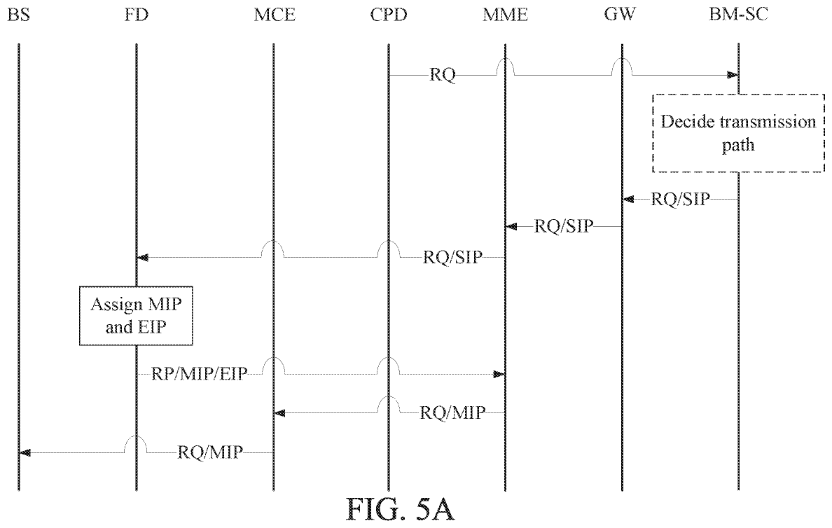

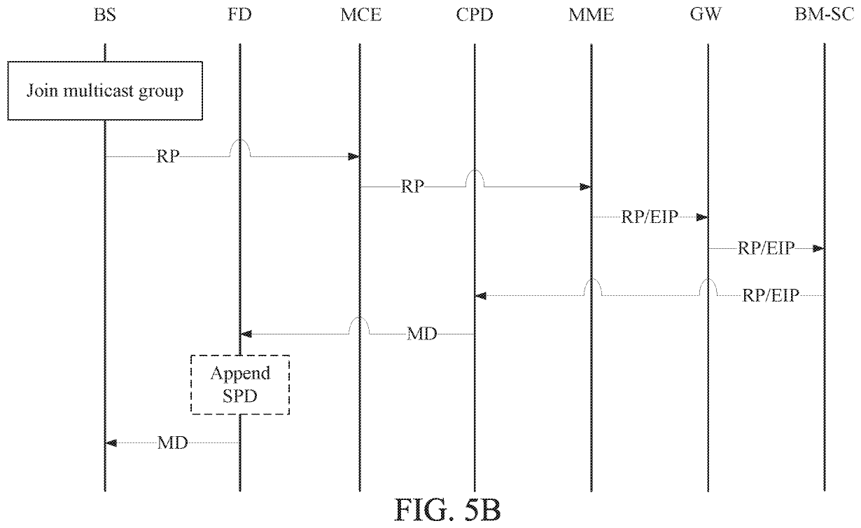

FIG. 5A and FIG. 5B illustrate a schematic view of how the communication system shown in FIG. 2D provides MBMS according to one or more embodiments of the present invention. However, contents of FIG. 5A and FIG. 5B are presented merely for explaining the embodiments of the present invention, but not to limit the present invention.

Referring to FIG. 2D and FIGS. 5A-5B, when the communication system 2D is attempting to provide MBMS, the content provider CPD may transmit an MBMS session-start request RQ to the broadcast/multicast service center BM-SC on the control plane. In some embodiments, if the communication system 2D is able to support both of a conventional transmission path (i.e., the MBMS data of the content provider CPD needs to be transmitted to the broadcast/multicast service center BM-SC) and the improved transmission path (i.e., the MBMS data of the content provider CPD does not need to be transmitted to the broadcast/multicast service center BM-SC), the broadcast/multicast service center BM-SC may decide and choose one from the two transmission paths based on various factors (for example but not limited to: the network transmission status, the current workload, etc.) after receiving the MBMS session-start request RQ. Under the circumstances, the broadcast/multicast service center BM-SC also affects the subsequent operations of the MBMS data forwarding device FD. The subsequent operations of the MBMS data forwarding device FD may at least include transmitting an entry network address EIP to the content provider CPD and transmitting a multicast internet protocol address MIP to the base station BS.

When the improved transmission path (i.e., the MBMS data of the content provider CPD does not need to be transmitted to the broadcast/multicast service center BM-SC) is chosen, the MBMS session-start request RQ may be transmitted on the control planes from the broadcast/multicast service center BM-SC to the MBMS data forwarding device FD through the MBMS gateway GW and the mobility management entity MME. The MBMS session-start request RQ transmitted to the MBMS data forwarding device FD may carry a source network address SIP associated with the content provider CPD. According to the source network address SIP, the MBMS data forwarding device FD may identify the content provider CPD whose MBMS data is received afterwards by itself. For different requirements, the source network address SIP may comprise only a source internet protocol (IP) address, or may comprise the source internet protocol address and a source port.

After receiving the MBMS session-start request RQ, the MBMS data forwarding device FD may create a multicast group and assign a multicast internet protocol address MIP associated with the multicast group for the base station BS. At the same time, the MBMS data forwarding device FD may assign an entry network address EIP for the content provider CPD. Then the MBMS data forwarding device FD may append the multicast internet protocol address MIP and the entry network address EIP to the MBMS session-start response RP which is to be transmitted to the mobility management entity MME. After the mobility management entity MME receives the MBMS session-start response RP carrying the multicast internet protocol address MIP and the entry network address EIP from the MBMS data forwarding device FD, the MBMS session-start response RP carrying the multicast internet protocol address MIP may be transmitted on the control planes from the mobility management entity MME to the base station BS through the MBMS coordination entity MCE. Upon receipt of the MBMS session-start request RQ, the base station BS may join the multicast group according to the multicast internet protocol address MIP. Any one of the broadcast/multicast service center BM-SC, the MBMS gateway GW, the mobility management entity MME, and the MBMS coordination entity MCE may directly forward the received MBMS session-start request RQ to the next node, or may modify the content and/or format of the received MBMS session-start request RQ, and then transmit the modified MBMS session-start request RQ to the next node.

After the base station BS joins the multicast group, it may transmit the MBMS session-start response RP on the control planes to the mobility management entity MME through the MBMS coordination entity MCE. Then, the mobility management entity MME may transmit the MBMS session-start response RP carrying the entry network address EIP on the control planes to the content provider CPD through the MBMS gateway GW and the broadcast/multicast service center BM-SC. Any one of the MBMS coordination entity MCE, the mobility management entity MME, the MBMS gateway GW and the broadcast/multicast service center BM-SC may directly forward the received MBMS session-start response RP to the next node, or may modify the content and/or format of the received MBMS session-start response RP, and then transmit the modified MBMS session-start response RP to the next node. For different requirements, the entry network address EIP may comprise only an entry internet protocol (IP) address, or may comprise the entry internet protocol address and an entry port.

After receiving the MBMS session-start response RP, the content provider CPD may directly transmit the MBMS data MD to the MBMS data forwarding device FD on the specific user plane between the content provider CPD and the MBMS data forwarding device FD according to the entry network address EIP. For example, after receiving the MBMS conference response RP, the content provider CPD may establish a forwarding tunnel (for example but not limited to an IPsec tunnel) on the specific user plane between the content provider CPD itself and the MBMS data forwarding device FD according to the entry network address EIP, and then directly transmit the MBMS data MD to the MBMS data forwarding device FD via the forwarding tunnel.

After receiving the MBMS data MD, the MBMS data forwarding device FD may forward, in a multicast way, the MBMS data MD to the base station BS that has joined the multicast group on the specific user plane between the MBMS data forwarding device FD and the base station BS. Then, the base station BS may provide the MBMS data MD to the user equipment which it serves.

In some embodiments, the MBMS data forwarding device FD may selectively append an MBMS synchronization (SYNC) protocol data SPD to the MBMS data MD to be transmitted to the base station BS. After receiving the MBMS data MD, the base station BS may obtain a time stamp from the MBMS synchronization protocol data SPD for synchronizing the MBMS data MD. Details of the synchronization protocol may be found by referring to “3GPP TS 25.446: “MBMS synchronisation protocol (SYNC)””.

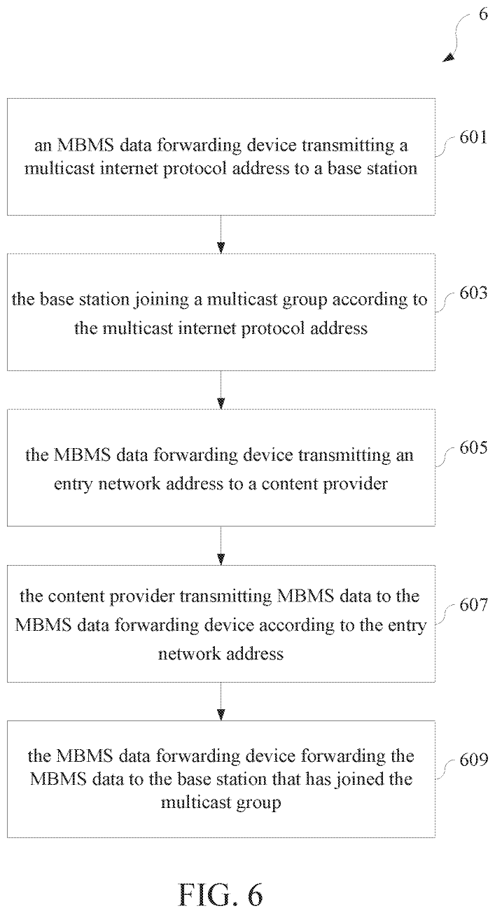

FIG. 6 illustrates a schematic view of a method of providing MBMS according to one or more embodiments of the present invention. However, contents of FIG. 6 are presented merely for explaining the embodiments of the present invention, but not to limit the present invention.

Referring to FIG. 6, a method 6 of providing multimedia broadcast/multicast service (MBMS) may comprise:

transmitting, by an MBMS data forwarding device, a multicast internet protocol address to a base station (marked as step 601);

joining, by the base station, a multicast group according to the multicast internet protocol address (marked as step 603);

transmitting, by the MBMS data forwarding device, an entry network address to a content provider (marked as step 605);

transmitting, by the content provider, MBMS data to the MBMS data forwarding device according to the entry network address (marked as step 607); and

forwarding, by the MBMS data forwarding device, the MBMS data to the base station that has joined the multicast group (marked as step 609).

In FIG. 6, the order in which steps 601 to 609 are presented is not a limitation. For example, in some embodiments, step 605 may be performed prior to performing step 601. In some embodiments, step 605 may be performed after step 601 is performed. In some embodiments, steps 601 and 605 may be performed simultaneously. In some embodiments, step 601 may be performed prior to performing step 607. In some embodiments, step 601 may be performed after step 607 is performed. In some embodiments, steps 607 and 601 may be performed simultaneously.

In some embodiments, the MBMS data forwarding device may be integrated into an MBMS coordination entity or an MBMS gateway.

In some embodiments, besides steps 601 to 609, the method 6 of providing multimedia broadcast/multicast service may further comprise the step of adding, by the MBMS data forwarding device, an MBMS synchronization protocol data to the MBMS data which is to be forwarded to the base station.

In some embodiments, the MBMS data forwarding device may be commanded by a broadcast/multicast service center to transmit the entry network address to the content provider and transmit the multicast internet protocol address to the base station.

In some embodiments, the method 6 of providing multimedia broadcast/multicast service may further comprise the following steps:

receiving, by the MBMS data forwarding device, a source network address of the content provider from a broadcast/multicast service center; and

identifying, by the MBMS data forwarding device, the MBMS data according to the source network address.

In addition to the aforesaid steps, in some embodiments, the method 6 of providing multimedia broadcast/multicast service may further comprise other steps corresponding to the operations of the communication system 2A, the communication system 2B, the communication system 2C and the communication system 2D as mentioned above. These steps which are not mentioned specifically can be directly understood by people having ordinary skill in the art based on the aforesaid descriptions for the communication system 1, and will not be further described herein.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication system in support of multimedia broadcast/multicast service (MBMS), comprising:
a content provider;
a base station; and
an MBMS data forwarding device coupled to the content provider and the base station respectively, the MBMS data forwarding device being configured to transmit an entry network address to the content provider, and transmit a multicast internet protocol address to the base station;
wherein:
the content provider is configured to transmit MBMS data to the MBMS data forwarding device according to the entry network address;
the base station is configured to join a multicast group according to the multicast internet protocol address; and
the MBMS data forwarding device is further configured to forward the MBMS data to the base station that has joined the multicast group.

2. The communication system of claim 1, wherein the MBMS data forwarding device is integrated into an MBMS coordination entity or an MBMS gateway.

3. The communication system of claim 1, wherein the MBMS data forwarding device is further configured to add an MBMS synchronization protocol data to the MBMS data which is to be forwarded to the base station.

4. The communication system of claim 1, wherein the MBMS data forwarding device is commanded by a broadcast/multicast service center to transmit the entry network address to the content provider and transmit the multicast internet protocol address to the base station.

5. The communication system of claim 1, wherein the MBMS data forwarding device is further configured to receive a source network address of the content provider from a broadcast/multicast service center, and identify the MBMS data according to the source network address.

6. A method of providing multimedia broadcast/multicast service (MBMS), comprising:
transmitting, by an MBMS data forwarding device, a multicast internet protocol address to a base station;
joining, by the base station, a multicast group according to the multicast internet protocol address;
transmitting, by the MBMS data forwarding device, an entry network address to a content provider;
transmitting, by the content provider, MBMS data to the MBMS data forwarding device according to the entry network address; and
forwarding, by the MBMS data forwarding device, the MBMS data to the base station that has joined the multicast group.

7. The method of claim 6, wherein the MBMS data forwarding device is integrated into an MBMS coordination entity or an MBMS gateway.

8. The method of claim 6, further comprising:
adding, by the MBMS data forwarding device, an MBMS synchronization protocol data to the MBMS data which is to be forwarded to the base station.

9. The method of claim 6, wherein the MBMS data forwarding device is commanded by a broadcast/multicast service center to transmit the entry network address to the content provider and transmit the multicast internet protocol address to the base station.

10. The method of claim 6, further comprising:
receiving, by the MBMS data forwarding device, a source network address of the content provider from a broadcast/multicast service center; and
identifying, by the MBMS data forwarding device, the MBMS data according to the source network address.

11. A multimedia broadcast/multicast service (MBMS) data forwarding device, comprising:
a transceiver configured to:
transmit an entry network address to a content provider to receive MBMS data from the content provider;
transmit a multicast internet protocol address to a base station such that the base station joins a multicast group according to the multicast internet protocol address; and
forward the MBMS data to the base station that has joined the multicast group; and
a processor electrically connected with the transceiver, configured to assign the multicast internet protocol address for the base station and assign the entry network address for the content provider.

12. The MBMS data forwarding device of claim 11, wherein the MBMS data forwarding device is integrated into an MBMS coordination entity or an MBMS gateway.

13. The MBMS data forwarding device of claim 11, wherein the processor is further configured to add an MBMS synchronization protocol data to the MBMS data which is to be forwarded to the base station.

14. The MBMS data forwarding device of claim 11, wherein the transceiver is commanded by a broadcast/multicast service center to transmit the entry network address to the content provider and to transmit the multicast internet protocol address to the base station.

15. The MBMS data forwarding device of claim 11, wherein the transceiver is further configured to receive a source network address of the content provider from a broadcast/multicast service center, and the processor is further configured to identify the MBMS data according to the source network address.
